(19) United States
(12) Patent Application Publication
(10) Pub. No.: US 2010/0045630 A1
(43) Pub. Date: Feb. 25, 2010

(54) Capacitive MEMS-Based Display with Touch Position Sensing

(75) Inventors: Shiqun Gu, San Diego, CA (US); Matthew Nowak, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/194,412

(22) Filed: Aug. 19, 2008

(51) Int. Cl. G06F 3/045

(52) U.S. Cl. 345/174

(57) ABSTRACT

A micro-electro-mechanical systems (MEMS) pixel for display and touch position sensing includes a substrate and a capacitive element. The capacitive element includes one or more pixels having a first conductive platelet above the substrate, and a second conductive platelet above and spaced apart from the first conductive platelet, the two platelets forming the capacitive element. A connection to each platelet provides for applying a voltage, wherein the platelet separation changes according to the applied voltage. A transparent dielectric plate, spaced apart from and positioned opposite the substrate, covers the at least one pixel. A capacitance sensing circuit attached to the connection to each platelet of the pixel senses changes in capacitance not resulting from the applied voltage.

### FIELD OF DISCLOSURE

The present disclosure relates generally to a MEMS display and method of operation and, more particularly, to a MEMS display capable of position touch sensing.

### BACKGROUND

A number of display devices include touch position sensing to enable graphical interactive selection of features in a screen display application. There are several different approaches in the current art to accomplishing touch position sensing. For example, a resistive touch panel may use two layers of separated conductive material. Pressure to the top layer, by force of finger contact, for example, may deform the top layer, bringing it into contact with the lower layer. The contact location is computed by measuring the voltage at the contact point. However, this type of sensor is highly mechanical in nature and aging or fatigue in the conductive material may adversely affect the long term stability of such a device.

Another touch sensor in use with display panels is based on capacitive sensing. For example, two orthogonal rows of conductive traces in layers separated by an insulating substrate and over-coated with an insulating and protective surface is known in the art. The capacitance between any two orthogonally crossing traces can be sensed. The proximity of, for example a finger, to any of the crossing traces causes a change in the sensed capacitance at that location. This occurs because the body of the user is substantially at ground potential with respect to one layer of traces, but not the other. However, the resolution for position location may be limited by the resolution of the traces.

One form of capacitive sensing operates by deforming the spacing between the two layers of sensor electrodes, physically changing the capacitance. The electrodes do not make physical contact, but change proximity. Another form of capacitive sensing is non-contact; that is, by sensing the fringing field of the capacitance induced, for example, between a finger, a hand or grounded stylus in close proximity to a portion of the sensor array.

Conventionally, such capacitive sensors are devices distinct and separate from and are placed over of the display screen as an additional structure, which may incur additional manufacturing costs. Moreover, in order to make the electrodes substantially invisible to the human eye the electrodes are, in some embodiments, made very narrow, or made of transparent conductors such as, for example, indium tin oxide (ITO).

In the current approaches described above, it is generally necessary to implement the touch sensor as a separate device either above or beneath the display. This may require additional manufacturing processes and increase the thickness of the display device.

### SUMMARY

Disclosed herein is a method and apparatus for sensing touch or proximity to an image display screen, wherein the display methodology is based on capacitive effects to provide the image. The image may be comprised of elements, such as pixels, and therefore, the capacitive property of the pixel is accessed to detect a presence or contact to the display by means of sensing circuitry in communication with the display. No additional structures or apparatus pertaining to the display structure beyond that required to provide the image are required.

In an embodiment, a micro-electro-mechanical systems (MEMS) pixel for display and touch position sensing, includes a first conductive platelet and a second conductive platelet disposed opposite and electrically insulated from the first platelet, the first and second platelets forming a capacitor. The pixel includes an optical cavity having a gap dimension associated with the relative positions of the first and second platelets. Driving circuitry applies a voltage difference to the first and second platelets, wherein the separation between the platelets is changed by electrostatic attraction from a first position to a second position, changing the gap dimension of the associated optical cavity and the capacitance of the first and second platelets simultaneously. Sensing circuitry coupled to the first and second platelets determine the capacitance and/or change in the capacitance corresponding to the relative positions of the first and second platelets.

In an embodiment, a method of sensing touch position in a MEMS display pixel, includes determining the capacitance state of the pixel. The pixel includes a first conductive platelet and a second conductive platelet disposed opposite and electrically insulated from the first platelet, the first and second platelets forming a capacitor. The method includes applying a difference voltage to the platelets to control a separation between the platelets and measuring the capacitance of the platelets corresponding to the separation. If the measured capacitance does not match the expected capacitance within a selected tolerance, a touch or proximity to contact condition is determined to be detected.

A MEMS display includes an array of pixels arranged in columns and rows, wherein each pixels comprises a first conductive platelet and a second conductive platelet disposed opposite and electrically insulated from the first platelet. The first and second platelets form a capacitor. Each pixel corresponds to an optical cavity having a gap dimension associated with the relative positions of the first and second platelets. The display includes an array driver controller comprising a column line for each column of pixels, a row line for each row of pixels, a column driver circuit, a row driving circuit, and a sensor controller circuit. The column driver circuit provides a processor controlled first voltage to each column line wherein the first conductive platelet of each pixel in a column is electrically connected to the corresponding column line. The row driver circuit provides a processor controlled second voltage to each row line wherein the second conductive platelet of each pixel in a row is electrically connected to the corresponding row line. The sensor controller circuit is configured to sense a capacitance between the first and second platelet in each pixel.

A method of sensing proximity and/or touch position in a capacitive MEMS display includes addressing an image to an array of pixels in the capacitive MEMS display and determining a state of the each of the pixels corresponding to the addressed image. An expected value of capacitance is specified for each pixel corresponding to the state of the pixel. A tolerance value is specified as a matching condition for an acceptable range of the specified capacitance. The capacitance value of each pixel is measured and compared to the expected capacitance value. A touch or proximity contact has been detected if the difference in the measured and expected capacitance exceeds the matching condition specified by the tolerance value, and the difference value is stored in a processor memory with a corresponding location of the pixel in the array. A touch or proximity contact has not been detected if the difference in the measured and expected capacitance value is equal to or less than the tolerance value, and a null value for the difference is stored in the processor memory with a corresponding location of the pixel in the array. The stored difference and null values are processed to determine a touch or proximity contact location.

The foregoing has outlined rather broadly the features and technical advantages of the present invention in order that the detailed description disclosed that follows may be better understood. Additional features and advantages will be described hereinafter which form the subject of the claims of the disclosure. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram showing an exemplary wireless communication system in which an embodiment of the invention may be advantageously employed;

FIG. 2 is a cross-section view of two capacitive MEMS display pixels, according to an embodiment of the disclosure;

FIG. 3A is an equivalent circuit of a single capacitive MEMS display pixel in proximity to a grounded object (e.g., finger), according to an embodiment of the disclosure;

FIG. 3B is a plot illustrating the dependence of effective capacitance on proximity to an external grounded object, according to the equivalent circuit of FIG. 3A;

FIG. 4 is a flow diagram of a method of sensing touch and proximity using a capacitive MEMS display pixel;

FIG. 5 is a block diagram of a capacitive MEMS touch sensing display, according to an embodiment of the disclosure; and

FIG. 6 is a flow diagram of a method of determining touch location in a capacitive MEMS touch sensing display, according to an embodiment of the disclosure.

### DETAILED DESCRIPTION

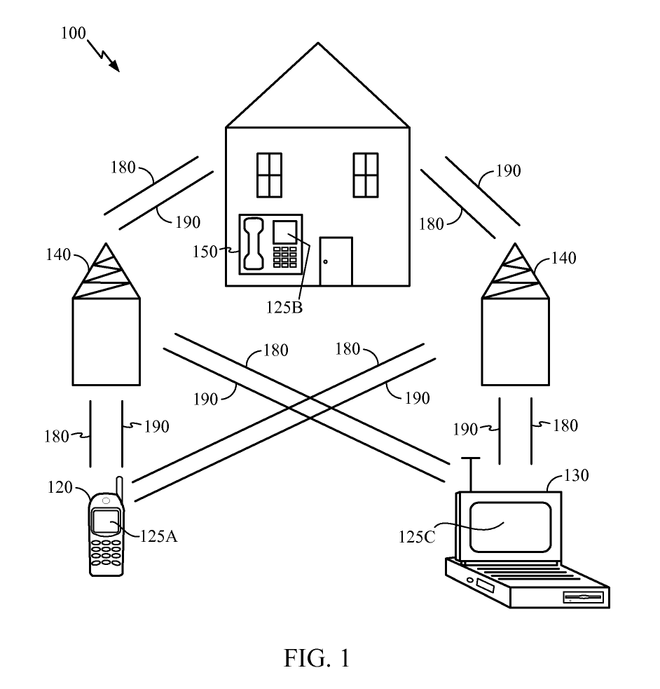

FIG. 1 shows an exemplary wireless communication system 100 in which an embodiment of the disclosure may be advantageously employed. For purposes of illustration, FIG. 1 shows three remote units 120, 130, and 150 and two base stations 140. It will be recognized that typical wireless communication systems may have many more remote units and base stations. Remote units 120, 130, and 150 include capacitance-based displays with touch sensing 125A, 125B, and 125C, respectively, which are embodiments of the invention as discussed further below. FIG. 1 shows forward link signals 180 from the base stations 140 and the remote units 120, 130, and 150 and reverse link signals 190 from the remote units 120, 130, and 150 to base stations 140.

In FIG. 1, remote unit 120 is shown as a mobile telephone, remote unit 130 is shown as a portable computer, and remote unit 150 is shown as a fixed location remote unit in a wireless local loop system. For example, the remote units may be cell phones, hand-held personal communication systems (PCS) units, portable data units such as personal data assistants, or fixed location data units such as meter reading equipment. Although FIG. 1 illustrates remote units according to the teachings of the invention, the invention is not limited to these exemplary illustrated units. The invention may be suitably employed in any device which includes a display with touch sensing.

U.S. Pat. No. 7,321,457 issued Jan. 28, 2008, to HEALD, the disclosure of which is herein expressly incorporated by reference in its entirety, discloses a MEMS interferometric modulator (iMOD) display element currently being used for active display. The MEMS display is a capacitive device. Herein, a method and system of providing a capability to sense and provide touch position location based on the capacitance properties of the device are disclosed. In one or more embodiments described herein, no additional sensing structures need be added to the display. Additional circuitry coupled to the display elements may be adapted to obtain and evaluate the sensed signals and determine touch location.

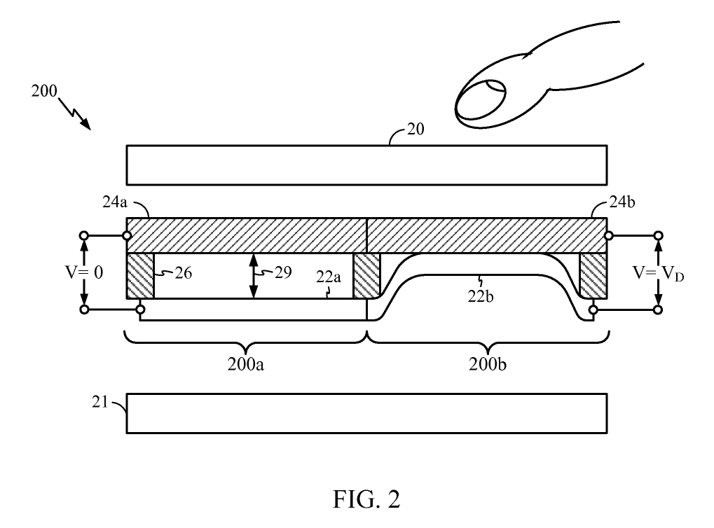

FIG. 2 shows a cross-section of an embodiment of a pair of MEMS-based interferometric light modulator (iMOD) display pixels 200a and 200b. A single display pixel, such as a pixel 200a, includes two parallel conductive platelets, i.e., a bottom platelet 22a (22b for pixel 200b) and a top platelet 24a (24b for pixel 200b), respectively. Both bottom and top platelets 22a, 22b, 24a and 24b include at least a conductive layer (not shown) which may serve at least as an electrode, reflective surface, or both. Alternatively, reflective and conductive layers may be provided separately. The top platelet 24a is spaced apart from bottom plate 22a by supporting pillar 26. The display pixel elements 200a and 200b are disposed adjacent to a supporting base 21, which may be, for example, a silicon substrate or a glass substrate, but may include other substrate materials. Alternatively the display pixel elements may be supported by a transparent dielectric cover plate 20 disposed above the top platelets 24a and 24b. Cover plate 20 also protects and electrically isolates pixel 200 from external charge. The cover plate 20 may be, for example, the screen or outer shield of a display.

When a driving voltage bias is changed from V=0 to V=V_{D} and is applied between platelets 22b and 24b, the electrostatic field produced will generate an attractive force to change the spacing between the platelets, as shown by spacing from a zero bias voltage for platelets 22a and 24a, relative to the spacing shown for V=V_{D} for platelets 22b and 24b. In an embodiment as shown in FIG. 2, platelet 22b deforms toward platelet 24b. However, in other embodiments platelet 24b could deform toward platelet 22b, or both could deform toward each other. One or both of the platelets may be associated with an optical cavity. In one embodiment, the optical cavity is defined by the space between the platelets. Alternatively, in another embodiment, the optical cavity is defined by the space between one platelet and another reflecting surface outside and apart from both platelets. The volume of the optical cavity changes as the spacing between the platelets change. The associated optical cavity is further defined by two reflecting surfaces spaced apart and having specified reflection and transmission properties at each reflecting surface to enhance constructive or destructive interference of light in a selected wavelength range.

Through proper selection of the transmissive and reflective properties of the reflecting layers of the platelets, the net reflectivity of the pixel in a destructive interference state may be as low as approximately 1%-2%, or lower at the selected wavelength range, giving the appearance of a black pixel. Conversely, when the optical cavity is in a second state, where the optical path length corresponds to constructive interference, pixel brightness may approach 90%, or more, i.e., a bright pixel at the selected wavelength range.

In either of the two states—relaxed or collapsed—the two electrodes of the platelets form a capacitor that may be approximated as two parallel plates separated by a gap 29 which may include air and dielectric layer material. In the relaxed (“off”) state the capacitance may be denoted as Cr, and in the collapsed (“on”) state the capacitance may be denoted by Cc. Because parallel plate capacitance is approximately inversely proportional to the gap 29, it can be seen that Cc>Cr. The pixel will have a measured capacitance of one or the other of these two values Cc or Cr, depending on the pixel state (collapsed or relaxed). For simplicity, we may refer to the pixel capacitance as C, for either state.

In the embodiment of FIG. 2, assume that bottom platelet 22a (22b) is at a relative electrical ground potential (an arbitrary designation, such as the device case potential). In a hand held portable device, such as remote units 120, 130 (FIG. 1), with a display comprised of an array of capacitive MEMS pixel elements 200 covered by a transparent screen 20, the device user is effectively at case ground potential, and a source of considerable mobile charge. Bringing a finger or conductive stylus grounded to the user in contact or proximity (“proximity contact”) with the cover plate 20 over a pixel creates an additional effective “extra” capacitance Cx between the top platelet 24a (24b) and relative ground.

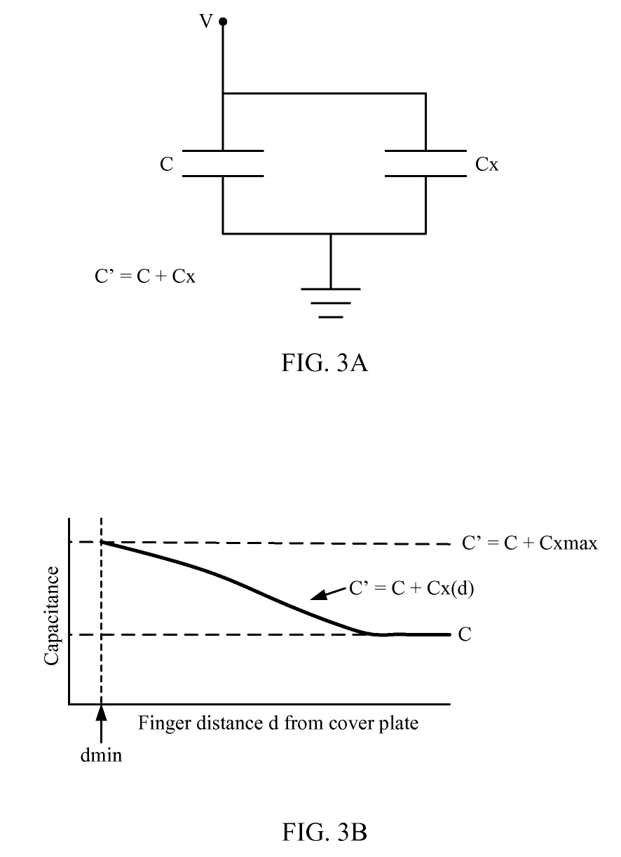

FIG. 3A represents an equivalent circuit approximation of a single pixel and finger contributions to total capacitance. At distances large compared to the pixel gap the finger capacitance Cx is effectively zero, so only the pixel capacitance is apparent. When a finger or grounded stylus, for example, is brought in proximity or contact with cover plate 20 above the pixel, the effective external capacitance increases to a maximum Cx=Cxmax, limited by the closest proximity of the finger to the pixel by the thickness of cover plate 20. The corresponding total effective capacitance is approximately the sum of the two capacitances in parallel, i.e., C′=C+Cx(d), where d corresponds approximately to a distance between the finger and top platelet 24a (24b).

FIG. 3B represents the change in effective capacitance C′ as a function of the distance between the finger (or grounded stylus) and the pixel. A sensing circuit connected to the pixel top platelet and bottom platelet may then measure C′. Assuming that the state of the pixel is known, and therefore the expected value of C (either Cr or Cc) is known within a certain accuracy tolerance ε, a difference in the measured capacitance from one of the expected values may be determined to indicate that a region of the display area containing the pixel is being touched or that close proximity to contact is evident.

Various sensing circuitry and methods may be provided to sense a change in capacitance. In one embodiment (not shown), the capacitance may be coupled to an inductive reference element L and a feedback amplifier circuit to function as an oscillator, which operates at the L-C resonance frequency determined by the effective capacitance C′ associated with a pixel. Each state of the pixel (relaxed or collapsed) will have an associated expected oscillator frequency in the absence of externally coupled capacitance. A measured oscillation frequency that is different from the expected oscillation frequency indicates a touch contact or proximity to contact is evident. The inductor value may be chosen so that the oscillating frequency of the resonant circuit formed is well above a frequency range associated with scanning an array of display pixels. The embodiment indicated above for measuring capacitance and determining touch is exemplary and not intended to be exhaustive.

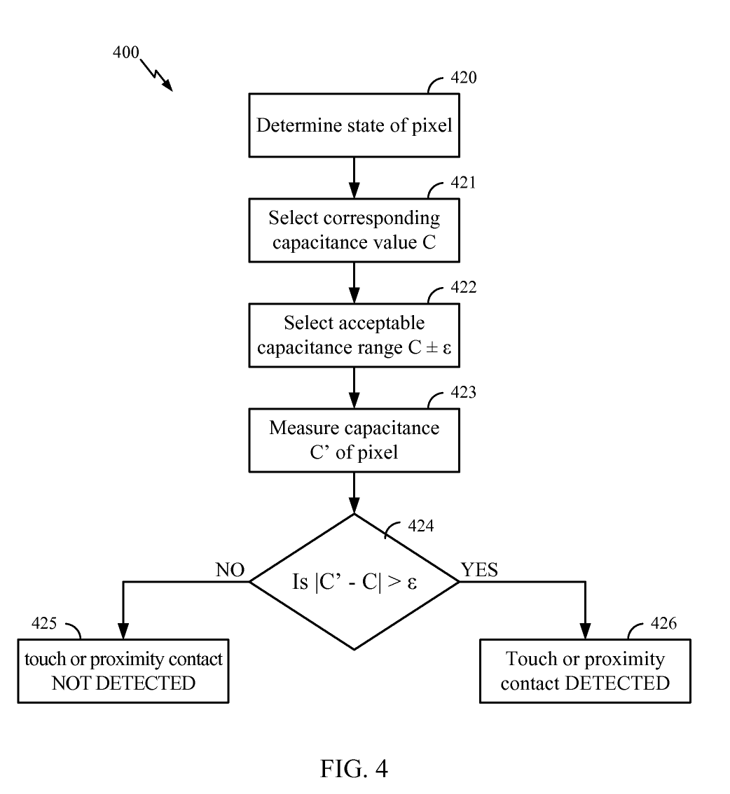

FIG. 4 is a flow diagram of an exemplary method of sensing capacitance using a capacitive MEMS display pixel element 200. Block 420 determines the state of the pixel, for example, by the value of the applied voltage between the platelets. Block 421, based upon the determined state of the pixel results, selects a known value of capacitance corresponding to the state of the pixel. This state may be Cr or Cc. Because manufacturing processes may often have tolerance limits on dimensions, compositions, etc., block 422 determines a tolerance limit ε to establish an acceptable capacitance range, e.g., C±ε. Block 423 measures the capacitance of the pixel to a measured value C′. C′ may be within the tolerance limit of ε or not. Block 424 compares C′ and C. If the absolute value difference in measured and expected values, i.e., |C′−C| is equal or less than ε then block 425 indicates a “no touch” condition. If the absolute value difference between the measured and expected capacitance exceeds the tolerance limit ε then block 426 indicates that a touch (or proximity) contact has been detected.

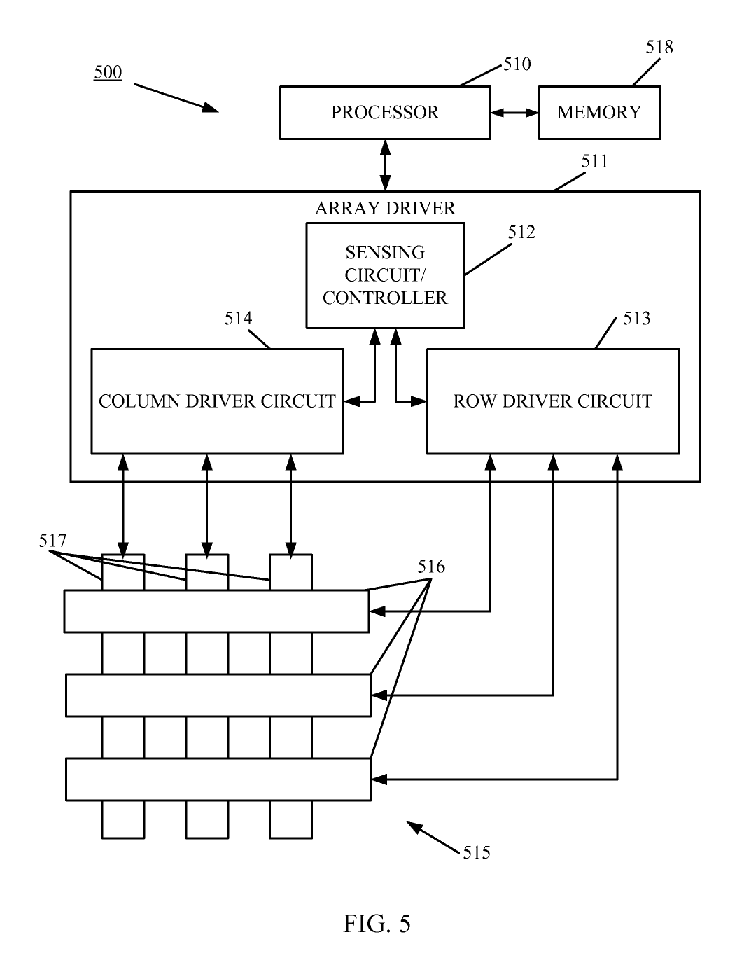

FIG. 5 is a block diagram illustrating one embodiment of a capacitive MEMS touch sensing display system 500. The display system 500 includes a processor 510, which may be any special or general purpose single or multi-chip processor, and associated memory 518. The processor 510 is configured to communicate with an array driver 511. In one embodiment, the array driver 511 includes a row driver circuit 513 and a column driver circuit 514 that provide signals to a display array 515. The display array 515 is made up of pixels, such as pixels 200. In one embodiment, the array driver 511 includes a sensing controller circuit 512 in communication with the display array 515.

In some embodiments, upper platelets 24a (24b) (FIG. 2) are patterned into parallel strips, and may form row electrodes 516, and the lower platelets 22a (22b) are patterned into parallel strips, and may form column electrodes 517 in the display system 500. Alternatively, the lower platelets 12 may be patterned to form columns and the upper platelets 14 may be patterned to form rows.

In the embodiment shown in FIG. 5, the sensing controller 512 communicates with the pixels through the row driver circuit 513 and the column driver circuit 514. In another embodiment, the sensing controller may communicate directly with the row and column electrodes 516 and 517, respectively.

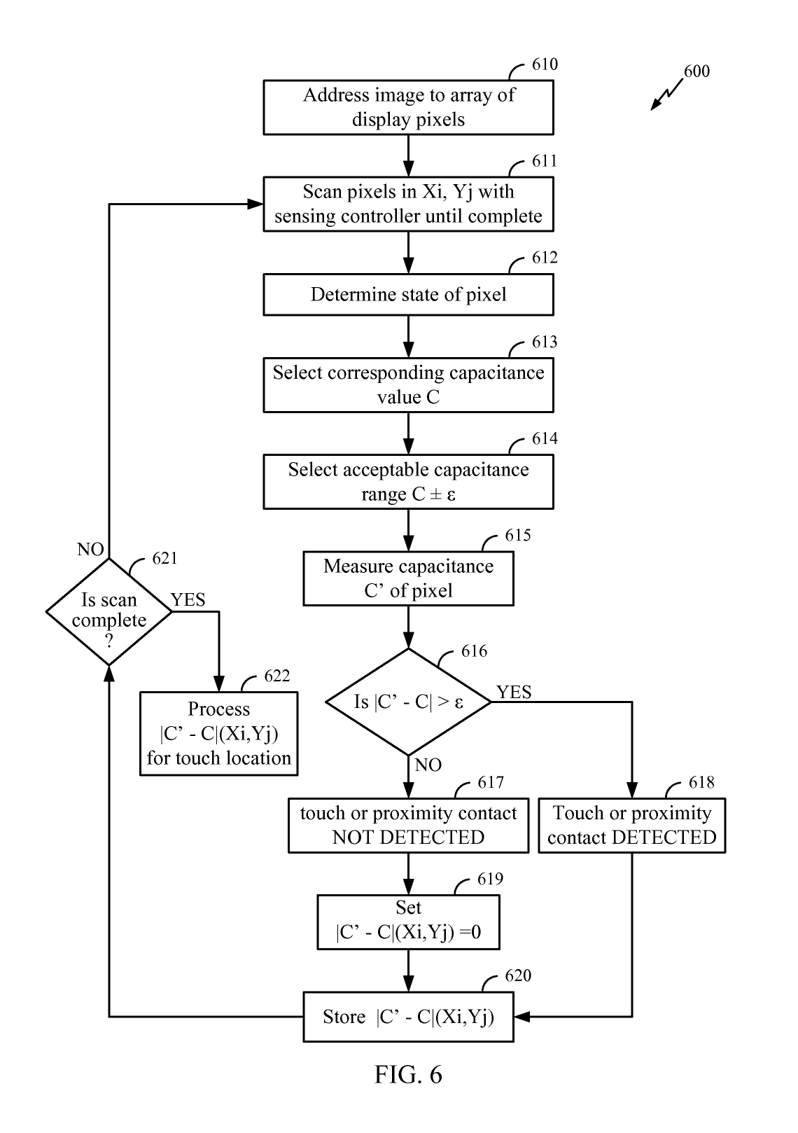

FIG. 6 shows one embodiment 600 of a flow diagram of a method of determining touch location in a capacitive MEMS touch sensing display. Block 610 addresses an image to the display array 515 (FIG. 5). Block 611 then scans the display array 515 with the sensing controller 512. The pixels in the display array 515 can be identified by indices i,j if the display array 515 is laid out, for examples, in rows and columns, and the capacitance sensing method is asserted on a pixel-by-pixel basis. A capacitance sensing measurement is associated with each pixel location, e.g., Xi,Yj. Blocks 612-618 are substantially the same as blocks 420-426 of the method 400 (FIG. 4), and are not discussed further.

If block 617 indicates a “no touch” condition, then block 619 sets the value of |C′−C| to a null value for the corresponding pixel i,j at location Xi,Yj, and block 620 stores the null value with the corresponding location in memory, such as the memory 518 of FIG. 5.

Block 621 determines if the scan is complete. If not, the method 600 continues at block 611 by sensing a next pixel (e.g., at Xi+k,Yj+l) and repeating blocks 612-618.

If block 618 indicates a touch condition, then block 620 stores the capacitance difference as determined by block 616 in correspondence with the position Xi,Yj of the pixel i,j. The method 600 then continues, as discussed above, with block 621 determining if the entire array has been scanned.

When block 621 determines that scanning is complete, block 622 processes the stored touch sensing data in memory to determine any touch location. For example, because a finger contact may indicate contact detection at a cluster of pixels, the data may be processed to determine a central contact position, based on various weighting calculations, which are well known in the image and signal processing arts. The processor 510, FIG. 5, may then initiate logical processes based on the touch location information so obtained to enable graphical interactive selection of features in a screen display application.

Although specific circuitry has been set forth, it will be appreciated by those skilled in the art that not all of the disclosed circuitry is required to practice the invention. Moreover, certain well known circuits have not been described, to maintain focus on the invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electronic display, comprising:
a plurality of pixels, each pixel comprising at least two material layers disposed in separated relationship to each other, said material operative to cause a respective pixel to change both a viewing state and a capacitance state according to an applied voltage;
a driving circuit operative to apply a voltage to each pixel; and
a sensing circuit for determining capacitance values of said pixels while said electronic display is in operation.

2. The display of claim 1 further comprising:
a processor for controlling the driving circuit and the sensing circuit; and
a memory operatively coupled to the processor for comparing an actual sensed capacitance value of a particular set of pixels at a point in time against an expected capacitance value at said point in time.

3. The display of claim 2 wherein said expected capacitance value at said point in time is dependent upon said viewing state of said pixel.

4. The display of claim 3 wherein said actual sensed capacitance at said particular set of pixels is dependent upon proximity of said particular pixels to an external stimuli.

5. The display of claim 4 wherein said external stimuli is a body extremity of a display operator.

6. The display of claim 4 wherein said external stimuli is a conductive stylus held by a display operator.

7. The display of claim 4 wherein said processor performs interactive control of said display driving circuit depending on the compared actual sensed capacitance and said expected capacitance of said particular set of pixels.

8. The display of claim 4 wherein one of said at least two material layers comprises a conductive film electrode.

9. The display of claim 4, further comprising a transparent cover sheet disposed adjacent to the plurality of pixels to prevent direct physical contact of the external stimuli to the display element.

10. A method for operating an electronic display comprised of a plurality of pixels, said method comprising:
providing an image to a display to place said pixels in a given status corresponding to the image;
determining at any point in time an expected capacitance of certain pixels according to the given status of said display;
determining an actual capacitance value of one or more of said certain pixels at said point in time; and
providing an indication dependent upon a match condition of a determined actual capacitance value at a particular pixel and an expected capacitance value at said particular pixel based upon a determined display status of said particular pixel.

11. The method of claim 10 wherein the actual capacitance value is dependent upon proximity of said particular pixels to an external stimuli.

12. The method of claim 10 wherein said external stimuli is a body part of a display operator.

13. The method of claim 10 wherein said external stimuli is a conductive stylus held by a display operator.

14. The method of claim 10 further comprising changing the display status in response to the indication.

15. An electronic display element enabled for touch sensing, comprising:
two pixel platelets having a variable separation, each platelet comprising at least one conductive layer, said conductive layers operative to cause a respective pixel to change both a viewing state and a capacitance state according to an applied voltage;
a driving circuit operational to apply a voltage to the two platelets to vary the separation, wherein the viewing state and the capacitance state of the element is varied in response to the applied voltage; and
a sensing circuit operatively coupled to the platelets to determine the capacitance of the platelets.

16. The display element of claim 15, further comprising:
a processor for controlling the driving circuit and the sensing circuit; and
a memory operatively coupled to the processor for comparing an actual sensed capacitance value of a particular pixel at a point in time against an expected capacitance value at said point in time.

17. The display element of claim 16 wherein said expected capacitance value at said point in time is dependent upon said viewing state of said particular pixel.

18. The display element of claim 17 wherein said actual sensed capacitance at said particular pixel is dependent upon proximity of said particular pixel to an external stimuli.

19. The display element of claim 18 wherein said external stimuli is a body part of a display operator or a conductive stylus held by the display operator.

20. The display element of claim 19 wherein said processor performs interactive control of said display driving circuit depending on the compared actual sensed capacitance and said expected capacitance of said particular pixel.
